(19) United States
(12) Patent Application Publication
(10) Pub. No.: US 2010/0216687 A1
(43) Pub. Date: Aug. 26, 2010

(54) FABRIC CONDITIONERS

(76) Inventors: Robert Allan Hunter, Wirral (GB); Mansur Sultan Mohammadi, Wirral (JP)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/676,147

(22) PCT Filed: Aug. 22, 2008
(86) PCT No.: PCT/EP2008/061039

§ 371 Date: May 6, 2010

(30) Foreign Application Priority Data
Sep. 8, 2007 (GB) 0717485.7
May 22, 2008 (EP) 08156743.0

(51) Int. Cl. C11D 3/395

(52) U.S. Cl. 510/518

(57) ABSTRACT

Compositions comprising unsaturated fatty chains have reduced or eliminated base off-odour with the incorporation of a photobleach.

### TECHNICAL FIELD

The present invention concerns the use of photobleach to reduce and eliminate fatty base odours in fabric conditioner compositions which contain actives having unsaturated fatty chains.

### BACKGROUND OF THE INVENTION

So-called ‘soft’ fabric softening actives derived from unsaturated fatty acyl or acid feedstock, have the advantages of ease of formulation and manufacture and a greater physical stability under varying climatic storage conditions, when compared to the so-called ‘hardened’ softeners (i.e. those derived from fully or nearly fully saturated fatty compounds).

However a disadvantage of ‘soft’ actives is the generation of an objectionable fatty base odour. This odour is believed to arise, at least in part, from rancidification of the double bonds in the fatty chains, due to auto-oxidation. Malodour is detectable in the raw material, in the formulated products and on the substrate itself, such as fabric, during and after treatment with these soft actives.

One general approach to solving malodour problems, found in the prior art, is to mask the malodour with perfume.

Perfume ingredients have been used to counteract the malodours generated on different substrates.

For example, WO 2008/026140 A2 (Firmenich), uses malodour counteracting mixtures of perfume ingredients containing at least one nitrile material in combination with another fragrance material to neutralise tobacco, bathroom or kitchen malodours, animal malodours, etc in a variety of products including textile treatment products such as fabric softeners.

WO 2006/058297 A1 (Procter & Gamble), uses perfume compositions for masking fatty acid odours in a range of cleaning and treatment compositions including laundry and dishwashing detergents, particularly those odours arising from enzyme-generated short chain fatty acids such as butyric acid.

WO 2006/066705 A1 (Unilever), describes a malodour reducing toilet bar composition comprising a pyranone derivative. Use of pyran-4-one derivates as a specific odour masking agent in toilet bars enables the inclusion of reduced levels of perfume in the bar composition.

However, these approaches tend to be expensive, often requiring increased levels of specialised perfume ingredients. Furthermore, in soft fabric conditioners, the base odour can often still be noticed as a background smell, particularly during in-wear after the perfume has evaporated.

Another approach can be found in the prior art whereby odour masking is achieved by non-perfume ingredients. For example, WO 2008/020058 A2 (Dresden University), describes the use of mono- or di-saccharides for masking odours.

We have found that consumers easily discern base off-odour from under a perfume. There remains a need for ways of eliminating malodour arising from raw-materials which contain unsaturated fatty chains in compositions comprising them.

Photobleach has been added to laundry compositions as a bleaching or cleaning agent.

WO 1998/32827 and U.S. Pat. No. 5,916,481 (Procter & Gamble) concern cleaning compositions containing photobleach and a detersive surfactant.

WO 2001/44424 (Unilever) discloses a fabric care composition which contains a radical initiator and a hardened quaternary ammonium compound.

WO 1999/20722 and US 2005/0153869 (Procter & Gamble) describe fabric softening and detergent compositions. A photobleach can be present at up to 0.1 wt % as an optional ingredient in the detersive compositions, which may also optionally comprise “AQA” (a non-ester containing quaternary compound) in combination with mid-branched fatty soaps.

We have now surprisingly found that the base odour of raw materials containing unsaturated fatty chains can be reduced or eliminated by the use of photobleaches. It is surprising that the use of photo oxidation, unlike auto oxidation, can remove the base off-odour, in the bottle headspace and on fabric after deposition. This is commercially significant because the clothes remain fresher for longer without the requirement for increased levels of perfume.

### STATEMENT OF THE INVENTION

According to the present invention there is provided a composition comprising a quaternary ammonium compound and a photobleach, wherein the quaternary ammonium compound has unsaturated fatty chains.

In a further aspect of the invention, there is provided the use of a photobleach to reduce base off-odour in a composition comprising a quaternary ammonium compound, wherein the quaternary ammonium compound has unsaturated fatty chains.

Further aspects of the invention provide for the use of a photobleach in a composition to improve freshness of laundered articles, to improve clean smell of laundered articles, to reduce musty smell which may arise on drying and to improve the longevity of fragrance of a laundry conditioning product.

### DETAILED DESCRIPTION OF THE INVENTION

### Photobleach

In the context of the present invention a “photo-bleach” is any chemical species which forms a reactive bleaching species on exposure to sunlight, and preferably is not permanently consumed in the reaction. Preferred photo-bleaches include singlet oxygen photo-bleaches and radical photo-bleaches, most preferably singlet oxygen photo-bleaches. Suitable photo-bleaches are described in more detail below. A single photo-bleach may be used, or a combination of photo-bleaches. Any suitable combination may be used, such as a combination of singlet oxygen photo-bleaches.

Preferred levels of photo-bleach present in the composition are from 0.00003% to 0.05%, preferably from 0.0001% to 0.04%, more preferably from 0.001% to 0.04%, even more preferably from 0.002% to 0.04% by weight of the total composition.

The presence of a photo-bleach helps avoid a “musty” smell which can arise on drying and provide either a neutral or a desirable fresh and clean smell on cotton containing fabrics without the use of perfume materials.

The present invention also extends to the use of a photo-bleach to improve the longevity of fragrance of a laundry conditioning product.

As noted above the photo-bleaches suitable for use in the present invention include singlet oxygen photo-bleaches and radical photo-bleaches.

### Singlet Oxygen Photo-Bleaches

Singlet oxygen photo-bleaches (PB) function as follows:

PB+light→PB*

PB*+³O₂→PB+¹O₂

The photo-bleach molecule absorbs light and attains an electronical excited state, PB*. This electronically excited state is quenched by triplet oxygen, ³O₂, in the surroundings to form singlet ¹O₂. Singlet oxygen is a highly reactive bleach.

Suitable singlet oxygen photo-bleaches may be selected from, water soluble phthalocyanine compounds, particularly metallated phthalocyanine compounds where the metal is Zn—or Al-Z1 or Al/Zn-Z1, where Z1 is a halide, sulphate, nitrate, carboxylate, alkanolate or hydroxyl ion. Preferably the phthalocyanin has 1-4 SO₃X groups covalently bonded to it where X is an alkali metal or ammonium ion. Such compounds are described in WO2005/014769 (Ciba). The photo-bleach may be selected from the group consisting of Acid Red 51, Tinolux BBS, Tinolux BMC and mixtures thereof. Preferred metal phthalocyanine compounds are Tinolux BBS and Tinolux BMC (Ciba).

Xanthene type dyes are preferred, particularly based on the structure:

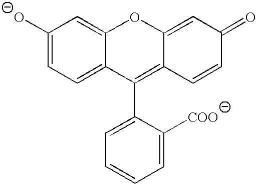

where the dye may be substituted by halogens and other elements/groups. Particularly preferred examples are Food Red 14 (Acid Red 51), Rose Bengal, Phloxin B and Eosin Y.

Quantum yields for photosensitized formation of singlet oxygen may be found in J. Phys. Chem. Ref. Data 1993, vol 22, nol pp 113-262. It is preferred if the quantum yield for singlet oxygen formation measured in an organic solvent or D₂O is greater than 0.05, more preferably greater than 0.1.

Other singlet oxygen producing compounds include chlorophyll, coumarin, porphyrins, myoglobin, riboflavin, bilirubin, and methylene blue.

The singlet oxygen photo-bleaches generally impart some colour to the fabric. To give the clothes an appealing white hue, it is preferred if blue or violet shading dyes are used in combination with the shading dyes as described in WO2005/003274 (Unilever) and WO2005/003277 (Unilever). Particularly preferred shading dyes are bis azo direct dyes of the direct violet 9, 35 and 99 type and acid azine dyes such as acid violet 50 and acid blue 98.

### Radical Photo-Bleaches

Radical photo-bleaches (radical photo-initiators) are well known chemicals in the plastics and curing industry. These applications have been widely discussed in the literature see e.g. H. F. Gruber Prog. Polym. Sci. 17 (1992), 953-1044 and references therein. They are organic chemicals which on exposure to light react to form neutral radicals that may initiate the polymerization of alkenes. Recently they have been found to be effective laundry photo-bleaches: UK patent application 9917451.8 teaches their use from main wash detergent powders and liquids, where the photo-initiators are intimately mixed into the powder or liquids.

Radical photo-bleaches are molecules that absorb light (typically 290-400 nm) to produce organic carbon-centered radicals.

Radical photo-bleaches may function by intermolecular hydrogen abstraction or by intramolecular alpha or beta bond cleavage.

Suitable radical photo-bleaches may be selected from quinones, ketones, aldehydes, and phosphine oxides. Preferably the maximum extinction coefficient is between 290 and 400 nm (measured in ethanol) is greater than 10, more preferably greater than 100 mol-1 L cm-1.

A particularly preferred class of radical photo-bleaches are based on the structure:

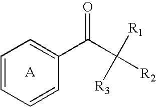

### Where,

R1 may be H, OH, Oalkyl preferably methoxy or ethoxy
R2 may be H, C1-C9 alkyl branched or linear
R3 may be H, C1-C9 alkyl

Preferably R1, R2 and R3 are hydrogen.

The phenyl ring, A, may be substituted at the 3, 4 and 5 position by:

C1-C9 allyl branched of linear, preferably methyl, ethyl, OR4 where R4 may be C1-C9 alkyl branched of linear, preferably methyl or ethyl.

Preferred examples of this type are acetophenone, 4 methyl acetophenone, 4 methoxy acetophenone. Benzophenone and vitamin K3 are also preferred radical photo-bleach.

Other suitable bond cleavage radical photo initiators may be selected from the following groups:

(a) alpha amino ketones, particularly those containing a benzoyl moiety, otherwise called alpha-amino acetophenones, for example 2-methyl 1-[4-phenyl]-2-morpholinopropan-1-one (Irgacure 907, trade mark), (2-benzyl-2-dimethyl amino-1-(4-morpholinophenyl)-butan-1-one (Irgacure 369, trade mark);
(b) alphahydroxy ketones, particularly alpha-hydroxy acetophenones, e.g. (1-[4-(2-hydroxyethoxy)-phenyl]-2-hydroxy-2-methyl-1-propan-1-one) (Irgacure 2959, trade mark), 1-hydroxy-cyclohexyl-phenyl-ketone (Irgacure 184, trade mark);
(c) phosphorus-containing photoinitiators, including monoacyl and bisacyl phosphine oxide and sulphides, for example 2-4-6-(trimethylbenzoyl)diphenyl-phosphine oxide, bis(2,4,6-trimethylbenzoyl)-phenyl-phosphine oxide (Irgacure 819, trade mark), (2,4,6-trimethylbenzoyl)phenyl phosphinic acid ethyl ester (Lucerin TPO-L (trade mark) ex BASF);
(d) dialkoxy acetophenones;
(e) alpha-haloacetophenones;
(f) trisacyl phosphine oxides;
(g) benzoin based photoinitiators; and
(h) thioxanthene based photoinitiators.

Further suitable radical photo-bleaches are disclosed in WO 9607662 (trisacyl phosphine oxides), U.S. Pat. No. 5,399,782 (phosphine sulphides), U.S. Pat. No. 5,410,060, EP-A-57474, EP-A-73413 (phosphine oxides), EP-A-088050, EP-A-0117233, EP-A-0138754, EP-A-0446175 and U.S. Pat. No. 4,559,371.

Yet further suitable photo-bleaches are disclosed for example in EP-A-0003002 in the name of Ciba Geigy, EP-A-0446175 in the name of Ciba Geigy, GB 2259704 in the name of Ciba Geigy (alkyl bisacyl phosphine oxides), U.S. Pat. No. 4,792,632 (bisacyl phosphine oxides), U.S. Pat. No. 5,554,663 in the name of Ciba Geigy (alpha amino acetophenones), U.S. Pat. No. 5,767,169 (alkoxy phenyl substituted bisacyl phosphine oxides) and U.S. Pat. No. 4,719,297 (acylphosphine compounds).

Radical photo-bleaches are discussed in general in A. F. Cunningham, V. Desorby, K. Dietliker, R. Husler and D. G. Leppard, Chemia 48 (1994) 423-426. They are discussed in H. F. Gruber Prog. Polym. Sci. 17 (1992) 953-1044.

Inorganic photo-bleaches, including titanium dioxide are not excluded, but are less preferred.

Preferred photo-bleaches have a microbicidal or microbistatic function against bacteria and/or fungi. Particularly preferred photo-bleaches show low reactivity with monounsaturated species so as to minimise reactions with the alkyl chains present in conditioner molecules. It is believed that the singlet oxygen photo-bleaches show low reactivity of this type. Where the photo-bleach is anionic in character it should be selected to have a low tendency to complex with the quaternary conditioner molecule with bulkier substituent groups being preferred over less bulky ones.

Some photo-bleaches impart colour to fabric. To give the clothes an appealing white hue, it is preferred if blue or violet shading dyes are used in combination with the photo-bleaches. Alternatively a combination of photo-bleaches is used to generate a white hue.

Preferred dyes are as described in WO2005/003274 (Unilever) and WO2005/003277 (Unilever). Particularly preferred shading dyes are bis azo direct dyes, particularly those of the direct violet 9, 35 and 99 type and acid azine dyes such as acid violet 50 and acid blue 98. Alternative shading dyes are described below.

### Quaternary Ammonium Compound

The present invention relates to quaternary ammonium compounds having unsaturated chains such that a base off-odour is generated. Such compounds are typically derived from fatty acid or acyl feed stock having an Iodine Value of from 20 to 140, preferably from 20 to 60, more preferably from 20 to 50, most preferably from 25 to 45. That is, it is preferred that the alkyl or alkenyl chains are substantially unsaturated. The unsaturated chains come from the unsaturated fatty feed stock. The quaternary ammonium compounds have iodine values which are similar to that of the fatty feed stock from which they are derived.

If there is a mixture of quaternary ammonium quaternary ammonium materials present in the composition, the iodine value, referred to above, represents the mean iodine value of the parent fatty acyl compounds or fatty acids of all of the quaternary ammonium materials present. Likewise, if there are any saturated quaternary ammonium materials present in the composition, the iodine value, referred to above, represents the mean iodine value of the parent fatty acyl compounds or fatty acids of all of the quaternary ammonium materials present. Where a mixture of soft and hard quaternary ammonium materials is used, the level of hardened material(s) is preferably less than 50% by weight of the total amount of quaternary ammonium material present, more preferably less than 20%, even more preferably less than 5% and most preferably less than 2%. However, preferably, no hardened material is present.

Such compounds have a strong base odour of parent fatty compound such as tallow or oily smells from other plant sources such as palm. High IV softener materials hence require odour masking perfume and increased perfume levels which this invention circumvents.

Iodine value is defined as the number of grams of iodine absorbed per 100 g of test material. NMR spectroscopy is a suitable technique for determining the iodine value of the softening agents of the present invention, using the method described in Anal. Chem., 34, 1136 (1962) by Johnson and Shoolery and in EP 593,542 (Unilever, 1993).

The quaternary ammonium compound is preferably present in the compositions of the invention at a level of from 2% to 55%, preferably from 3% to 50%, more preferably from 4% to 40% preferably from 5% to 30%, by weight of the total composition, for example from 6 to 20% by weight.

In another embodiment, the quaternary ammonium compound may be present at a level of greater than 80%, preferably 90% by weight of the total composition.

The preferred quaternary ammonium fabric conditioner for use in compositions of the present invention are the so called “ester quats”.

Particularly preferred materials are the ester-linked triethanolammonium (TEA) quaternary ammonium compounds comprising a mixture of mono-, di- and tri-ester linked components.

Typically, such TEA-based fabric softening compounds comprise a mixture of mono, di- and tri-ester forms of the compound. Typically the di-ester linked component comprises no more than 70% by weight of the fabric softening compound, preferably no more than 60%, e.g. no more than 55%, or even no more than 45% of the fabric softening compound and at least 10% of the monoester linked component.

A first group of quaternary ammonium compounds (QACs) suitable for use in the present invention is represented by formula (I):

[(CH₂)ₙ(TR)]ₘ—(R¹).N⁺—[(CH₂)ₙ(OH)]₃₋ₘX⁻ (I)

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO.O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are preparations which are rich in the di-esters of triethanolammonium methylsulphate, otherwise referred to as “TEA ester quats”.

Commercial examples include Prapagen™ TQL, ex Clariant, and Tetranyl™ AHT-1, ex Kao, (both di-[hardened tallow ester] of triethanolammonium methylsulphate), AT-1 (di-[tallow ester] of triethanolammonium methylsulphate), and L5/90 (di-[palm ester] of triethanolammonium methylsulphate), both ex Kao, and Rewoquat™ WE15 (a di-ester of triethanolammonium methylsulphate having fatty acyl residues deriving from C₁₀-C₂₀ and C₁₆-C₁₈ unsaturated fatty acids), ex Witco Corporation and the Stepantex (ex Stepan) soft range, Stepantex VT90, VA90, SP90, and hard range, Stepantex UL85.

A second group of quaternary ammonium compounds suitable for use in the invention is represented by formula (II):

(R¹)₃N⁺—(CH₂)ₙ—CH.(CH₂TR²)—TR²X⁻ (II)

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of quaternary ammonium compounds suitable for use in the invention is represented by formula (III):

(R¹)₂—N⁺—[(CH₂)ₙ-T-R²]₂X⁻ (III)

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride.

### Perfumes

The compositions of the present invention preferably comprise one or more perfumes. The perfume is preferably present in an amount from 0.01 to 10% by weight, more preferably from 0.05 to 5% by weight, even more preferably from 0.1 to 4.0%, most preferably from 0.2 to 4.0% by weight, based on the total weight of the composition.

Useful components of the perfume include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products, i.e., of imparting an odour and/or a flavour or taste to a consumer product traditionally perfumed or flavoured, or of modifying the odour and/or taste of said consumer product.

By perfume in this context is not only meant a fully formulated product fragrance, but also selected components of that fragrance, particularly those which are prone to loss, such as the so-called ‘top notes’.

Top notes are defined by Poucher (Journal of the Society of Cosmetic Chemists 6(2):80 [1955]). Examples of well known top-notes include citrus oils, linalool, linalyl acetate, lavender, dihydromyrcenol, rose oxide and cis-3-hexanol. Top notes typically comprise 15-25% wt of a perfume composition and in those embodiments of the invention which contain an increased level of top-notes it is envisaged at that least 20% wt would be present within the encapsulate.

Some or all of the perfume or pro-fragrance may be encapsulated, typical perfume components which it is advantageous to encapsulate, include those with a relatively low boiling point, preferably those with a boiling point of less than 300, preferably 100-250 Celsius and pro-fragrances which can produce such components.

It is also advantageous to encapsulate perfume components which have a low Clog P (i.e. those which will be partitioned into water), preferably with a Clog P of less than 3.0. These materials, of relatively low boiling point and relatively low Clog P have been called the “delayed blooming” perfume ingredients and include the following materials:

Allyl Caproate, Amyl Acetate, Amyl Propionate, Anisic Aldehyde, Anisole, Benzaldehyde, Benzyl Acetate, Benzyl Acetone, Benzyl Alcohol, Benzyl Formate, Benzyl Iso Valerate, Benzyl Propionate, Beta Gamma Hexenol, Camphor Gum, Laevo-Carvone, d-Carvone, Cinnamic Alcohol, Cinamyl Formate, Cis-Jasmone, cis-3-Hexenyl Acetate, Cuminic Alcohol, Cyclal C, Dimethyl Benzyl Carbinol, Dimethyl Benzyl Carbinol Acetate, Ethyl Acetate, Ethyl Aceto Acetate, Ethyl Amyl Ketone, Ethyl Benzoate, Ethyl Butyrate, Ethyl Hexyl Ketone, Ethyl Phenyl Acetate, Eucalyptol, Eugenol, Fenchyl Acetate, Flor Acetate (tricyclo Decenyl Acetate), Frutene (tricycico Decenyl Propionate), Geraniol, Hexenol, Hexenyl Acetate, Hexyl Acetate, Hexyl Formate, Hydratropic Alcohol, Hydroxycitronellal, Indone, Isoamyl Alcohol, Iso Menthone, Isopulegyl Acetate, Isoquinolone, Ligustral, Linalool, Linalool Oxide, Linalyl Formate, Menthone, Menthyl Acetphenone, Methyl Amyl Ketone, Methyl Anthranilate, Methyl Benzoate, Methyl Benzyl Acetate, Methyl Eugenol, Methyl Heptenone, Methyl Heptine Carbonate, Methyl Heptyl Ketone, Methyl Hexyl Ketone, Methyl Phenyl Carbinyl Acetate, Methyl Salicylate, Methyl-N-Methyl Anthranilate, Nerol, Octalactone, Octyl Alcohol, p-Cresol, p-Cresol Methyl Ether, p-Methoxy Acetophenone, p-Methyl Acetophenone, Phenoxy Ethanol, Phenyl Acetaldehyde, Phenyl Ethyl Acetate, Phenyl Ethyl Alcohol, Phenyl Ethyl Dimethyl Carbinol, Prenyl Acetate, Propyl Bornate, Pulegone, Rose Oxide, Safrole, 4-Terpinenol, Alpha-Terpinenol, and/or Viridine

Preferred non-encapsulated perfume ingredients are those hydrophobic perfume components with a ClogP above 3. As used herein, the term “ClogP” means the logarithm to base 10 of the octanol/water partition coefficient (P). The octanol/water partition coefficient of a PRM is the ratio between its equilibrium concentrations in octanol and water. Given that this measure is a ratio of the equilibrium concentration of a PRM in a non-polar solvent (octanol) with its concentration in a polar solvent (water), ClogP is also a measure of the hydrophobicity of a material—the higher the ClogP value, the more hydrophobic the material. ClogP values can be readily calculated from a program called “CLOGP” which is available from Daylight Chemical Information Systems Inc., Irvine Calif., USA. Octanol/water partition coefficients are described in more detail in U.S. Pat. No. 5,578,563.

Perfume components with a ClogP above 3 comprise: Iso E super, citronellol, Ethyl cinnamate, Bangalol, 2,4,6-Trimethylbenzaldehyde, Hexyl cinnamic aldehyde, 2,6-Dimethyl-2-heptanol, Diisobutylcarbinol, Ethyl salicylate, Phenethyl isobutyrate, Ethyl hexyl ketone, Propyl amyl ketone, Dibutyl ketone, Heptyl methyl ketone, 4,5-Dihydrotoluene, Caprylic aldehyde, Citral, Geranial, Isopropyl benzoate, Cyclohexanepropionic acid, Campholene aldehyde, Caprylic acid, Caprylic alcohol, Cuminaldehyde, 1-Ethyl-4-nitrobenzene, Heptyl formate, 4-Isopropylphenol, 2-Isopropylphenol, 3-Isopropylphenol, Allyl disulfide, 4-Methyl-1-phenyl-2-pentanone, 2-Propylfuran, Allyl caproate, Styrene, Isoeugenyl methyl ether, Indonaphthene, Diethyl suberate, L-Menthone, Menthone racemic, p-Cresyl isobutyrate, Butyl butyrate, Ethyl hexanoate, Propyl valerate, n-Pentyl propanoate, Hexyl acetate, Methyl heptanoate, trans-3,3,5-Trimethylcyclohexanol, 3,3,5-Trimethylcyclohexanol, Ethyl p-anisate, 2-Ethyl-1-hexanol, Benzyl isobutyrate, 2,5-Dimethylthiophene, Isobutyl 2-butenoate, Caprylnitrile, gamma-Nonalactone, Nerol, trans-Geraniol, 1-Vinylheptanol, Eucalyptol, 4-Terpinenol, Dihydrocarveol, Ethyl 2-methoxybenzoate, Ethyl cyclohexanecarboxylate, 2-Ethylhexanal, Ethyl amyl carbinol, 2-Octanol, 2-Octanol, Ethyl methylphenylglycidate, Diisobutyl ketone, Coumarone, Propyl isovalerate, Isobutyl butanoate, Isopentyl propanoate, 2-Ethylbutyl acetate, 6-Methyl-tetrahydroquinoline, Eugenyl methyl ether, Ethyl dihydrocinnamate, 3,5-Dimethoxytoluene, Toluene, Ethyl benzoate, n-Butyrophenone, alpha-Terpineol, Methyl 2-methylbenzoate, Methyl 4-methylbenzoate, Methyl 3, methylbenzoate, sec.Butyl n-butyrate, 1,4-Cineole, Fenchyl alcohol, Pinanol, cis-2-Pinanol, 2,4, Dimethylacetophenone, Isoeugenol, Safrole, Methyl 2-octynoate, o-Methylanisole, p-Cresyl methyl ether, Ethyl anthranilate, Linalool, Phenyl butyrate, Ethylene glycol dibutyrate, Diethyl phthalate, Phenyl mercaptan, Cumic alcohol, m-Toluquinoline, 6-Methylquinoline, Lepidine, 2-Ethylbenzaldehyde, 4-Ethylbenzaldehyde, o-Ethylphenol, p-Ethylphenol, m-Ethylphenol, (+)-Pulegone, 2,4-Dimethylbenzaldehyde, Isoxylaldehyde, Ethyl sorbate, Benzyl propionate, 1,3-Dimethylbutyl acetate, Isobutyl isobutanoate, 2,6-Xylenol, 2,4-Xylenol, 2,5-Xylenol, 3,5-Xylenol, Methyl cinnamate, Hexyl methyl ether, Benzyl ethyl ether, Methyl salicylate, Butyl propyl ketone, Ethyl amyl ketone, Hexyl methyl ketone, 2,3-Xylenol, 3,4, Xylenol, Cyclopentadenanolide and Phenyl ethyl 2 phenylacetate 2.

It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above and/or the list of perfume components with a ClogP above 3 present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

### Shading Dyes

As discussed above, an optional shading dye can be used to counteract the tendency of the photo-bleach to alter the hue of fabrics. Preferred dyes are violet or blue. Suitable and preferred classes of dyes are discussed below. Moreover the unsaturated quaternary ammonium compounds are subject to some degree of UV light and/or transition metal ion catalysed radical auto-oxidation, with an attendant risk of yellowing of fabric. The present of a shading dye also reduces the risk of yellowing from this source.

### Direct Dyes

Direct dyes (otherwise known as substantive dyes) are the class of water soluble dyes which have a affinity for fibres and are taken up directly. Direct violet and direct blue dyes are preferred.

Preferably the dye are bis-azo or tris-azo dyes are used.

Most preferably, the direct dye is a direct violet of the following structures:

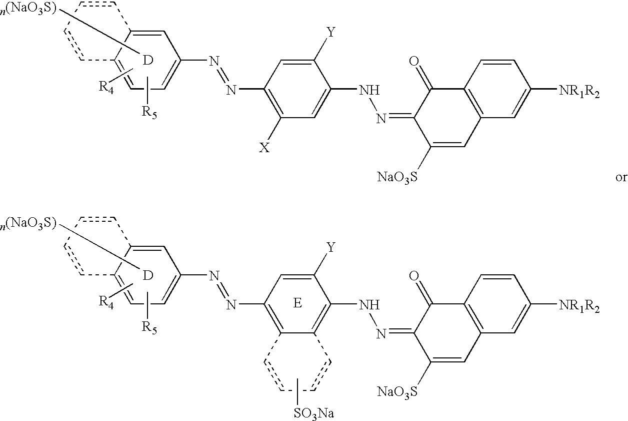

wherein:
ring D and E may be independently naphthyl or phenyl as shown;
R₁ is selected from: hydrogen and C1-C4-alkyl, preferably hydrogen;
R₂ is selected from: hydrogen, C1-C4-alkyl, substituted or unsubstituted phenyl and substituted or unsubstituted naphthyl, preferably phenyl;
R₃ and R₄ are independently selected from: hydrogen and C₁-C₄-alkyl, preferably hydrogen or methyl;
X and Y are independently selected from: hydrogen, C1-C4-alkyl and C1-C4-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes such as direct violet 66 may be used.

The benzidene based dyes are less preferred.

Preferably the direct dye is present at 0.00001 wt % to 0.0010 wt % of the formulation.

In another embodiment the direct dye may be covalently linked to the photo-bleach, for example as described in WO2006/024612.

### Acid Dyes

Cotton substantive acid dyes give benefits to cotton containing garments. Preferred dyes and mixes of dyes are blue or violet. Preferred acid dyes are:

(i) azine dyes, wherein the dye is of the following core structure:

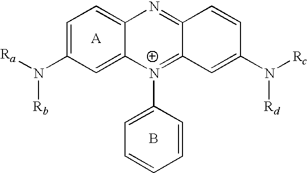

wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group;
the B ring does not carry a negatively charged group or salt thereof;
and the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt % to 0.01 wt % of the formulation.

### Hydrophobic Dyes

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt % to 0.005 wt % of the formulation.

### Basic Dyes

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

### Reactive Dyes

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species such as a polymer, so as to the link the dye to this species. Dyes may be selected from the reactive violet and reactive blue dyes listed in the Colour Index International. Preferred examples include reactive blue 19, reactive blue 163, reactive blue 182 and reactive blue, reactive blue 96.

### Dye Conjugates

Dye conjugates are formed by binding direct, acid or basic dyes to polymers or particles via physical forces.

Dependent on the choice of polymer or particle they deposit on cotton or synthetics. A description is given in WO2006/055787. They are not preferred.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

### Fluorescent Agents

In order to further improve whiteness, especially in the presence of both the photo-bleach and the shading dye, but also in the absence of the shading dye it is convenient and advantageous to include a fluorescer in the compositions of the invention. The composition therefore preferably further comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.005 to 2 wt %, more preferably 0.01 to 0.1 wt %.

Preferred classes of fluorescer are: Di-styryl biphenyl compounds, e.g. Tinopal™ CBS-X, Di-amine stilbene di-sulphonic acid compounds, e.g. Tinopal™ DMS pure Xtra and Blankophor™ HRH, and Pyrazoline compounds, e.g. Blankophor™SN.

Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

In a particularly preferred embodiment, the compositions of the present invention comprise:
a) a quaternary ammonium compound which is derived from fatty feed stock having an Iodine Value of from 20 to 140, preferably from 20 to 60, more preferably from 20 to 50, most preferably from 25 to 45,
b) from 0.00003 to 0.05, preferably from 0.0001 to 0.04, more preferably from 0.002% to 0.04% by weight of the total composition of at least one photo-bleach,
c) from 0.1 to 10 wt % of at least one perfume, and
d) from 0.005 to 2 wt % of at least one fluorescer.

It is preferred to use a shading dye in combination with a fluorescer in order to reduce yellowing due to chemical changes in adsorbed fluorescer.

### Further Components

Co-softeners may be used. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention will preferably comprise a fatty complexing agent. Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include hardened tallow fatty acid (available under the trade name Pristerene™, ex Uniqema). Preferred fatty alcohols include hardened tallow alcohol (available under the trade names Stenol™ and Hydrenol™, ex Cognis and Laurex™ CS, ex Albright and Wilson).

The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

The compositions may further comprise a nonionic surfactant, especially where the level of quaternary ammonium compound is above about 8% by weight of the total composition. Typically these can be included for the purpose of stabilising the compositions.

Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula:

R—Y—(C₂H₄O)_{z}—CH₂—CH₂—OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (C₁₋ariant) based on coco chain and 20 EO groups is an example of a suitable nonoionic surfactant.

The nonionic surfactant is present in an amount from 0.01 to 10%, more preferably 0.1 to 5 by weight, based on the total weight of the composition.

Alternative stabilising agents may be used. Alternative stabilisers include single long chain ethoxylated cationic surfactant with a counter ion which is preferably an alkyl sulphate, such as methyl sulphate and ethyl sulphate, and most preferably is a methylsulphate counter-ion.

The single long chain cationic surfactants alternatives are alkoxylated cationic quaternary ammonium surfactants. Those suitable for use in this invention are generally derived from fatty alcohols, fatty acids, fatty methyl esters, alkyl substituted phenols, alkyl substituted benzoic acids, and/or alkyl substituted benzoate esters, and/or fatty acids that are converted to amines which can optionally be further reacted with another long chain alkyl or alkyl-aryl group; this amine compound is then alkoxylated with one or two alkylene oxide chains each having less than or equal to about 50 moles alkylene oxide moieties (e.g. ethylene oxide and/or propylene oxide) per mole of amine. Typical of this class are products obtained from the quaternization of aliphatic saturated or unsaturated, primary, secondary, or branched amines having one hydrocarbon chain from about 12 to about 22 carbon atoms alkoxylated with one or two alkylene oxide chains on the amine atom each having less than or equal to about 50 alkylene oxide moieties. The amine hydrocarbons for use herein have from about 12 to about 22 carbon atoms, and are preferably in a straight chain configuration. Suitable quaternary ammonium surfactants are made with one or two alkylene oxide chains attached to the amine moiety, in average amounts of less than or equal to about 50 moles of alkylene oxide per alkyl chain, more preferably from about 3 to about 20 moles of alkylene oxide, and most preferably from about 5 to about 12 moles of alkylene oxide per hydrophobic, e.g., alkyl group. Examples of suitable stabilizers of this type include Ethoquad® 18/25, C/25, and 0/25 from Akzo and Variquat®-66 (soft tallow alkyl bis(polyoxyethyl) ammonium ethyl sulfate with a total of about 16 ethoxy units) from Goldschmidt.

Preferably, the compounds of the ammonium alkoxylated cationic surfactants have the following general formula:

{R1ₘ—Y—[(R2—O)_{z}—H]ₚ}⁺X⁻,

wherein R1 is selected from the group consisting of saturated or unsaturated, primary, secondary chain alkyl or alkyl-aryl hydrocarbons; said hydrocarbon chain having a length of from 12 to 22; each R2 is selected from the following groups or combinations of the following groups: —(CH₂)ₙ— and/or —[CH(CH₃)CH₂]—; Y is selected from the following groups: ═N⁺-(A)_{q}; —(CH₂)₂—N⁺-(A)_{q}; —B—(CH₂)ₙ—N⁺-(A)₂; -(phenyl)-N⁺-(A)_{q}; -(B-phenyl)-N⁺-(A)_{q}; with n being from about 1 to about 4.

Each A is independently selected from the following groups: H; R1; —(R2O)_{z}—H; —(CH₂)ₓCH₃; phenyl, and substituted aryl; where 0≦x≦about 3; and B is selected from the following groups: —O—; —NA-; —NA₂; —C(O)O—; and —C(O)N(A)-; wherein R2 is defined as hereinbefore; q=1 or 2; and X⁻ is and m is from 1 to 4.

Preferred structures are those in which m=1, p=1 or 2, and 5≦z≦50, more preferred are structures in which m=1, p=1 or 2, and 7≦z≦20, and most preferred are structures in which m=1, p=1 or 2, and 9≦z≦12.

Preferred commercial surfactants include Surfac ARF, a tallow amine ethoxy ammonium methyl sulphate (ex Surfachem); Tomah QC-15, cocopoly (15) oxyethylene methyl ammonium chloride (ex Tomah Products); and Rewoquat CPEM, coco pentaethoxymethyl ammonium methosulphate (ex Witco).

Another class of possible alternatives to non-ionic stabilisers are the long chain cationic surfactants based on quaternized amido-amine surfactants of the general structure;

R1—C(:O)—NH—[C(R2)(R3)]ₙ—N(CH₃)(R4)(R5)⁺X⁻

in which R1=C12-30-alkyl, -alkenyl, -arylalkyl, and -(cycloalkyl)alkyl; R2 and R3=H or C1-4-alkyl; R4 and R5=C₁₋₄-alkyl, -alkoxyalkyl, and -hydroxyalkyl; X⁻ is a halide or methylsulphate anion, preferably a methylsulphate anion counterion and n=1-10

Preferred commercial surfactants include Rewoquat V3351, a tallow alkyl amido-amine methyl sulphate quat (ex Goldschmidt), Surfac ARF, a tallow amine ethoxy ammonium methyl sulphate (ex Surfachem).

The amido-amine single long chain cationic surfactants for use in the present invention may be alkoxylated. These alkoxylated amido-amine single chain cationic surfactants comprise one or more alkylene oxide chains each having less than or equal to about 50 moles alkylene oxide moieties (e.g. ethylene oxide and/or propylene oxide) per mole of amine. The preferred alkoxylated surfactants for use in the present invention comprise at least one ethoxylate group.

Yet other class of possible alternatives are given WO 95/27771 and include amphoteric surfactants including betaines and tegobetaines.

### Further Optional Ingredients

The compositions of the invention may contain one or more other ingredients. Such ingredients include further preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, sunscreens, anti-corrosion agents, drape imparting agents, anti-static agents and ironing aids. The products of the invention preferably contain pearlisers and/or opacifiers.

It is believed that those polymers which deposit on cloth as a part of their activity may assist in the deposition of the photobleach and other perfume components present. These include cationic polymeric deposition aids. Suitable cationic polymeric deposition aids include cationic guar polymers such as Jaguar™ (ex Rhone Poulenc), cationic cellulose derivatives such as Celquats™ (ex National Starch), Flocald™ (ex National Starch), cationic potato starch such as SoftGel™ (ex Aralose), cationic polyacrylamides such as PCG (ex Allied Colloids).

To prevent photo-activation of the photo-bleach in the bottle, a photo-stable dye may be added to the formulation to shield the photo-bleach from light. Preferably this dye is not substantive to the fabric and therefore does not prevent photo-bleach activation on cloth. Alternatively clear bottles may include a UV filter but as many of the photo-bleaches are activated by visible light it is possible to use opaque bottles or select, for example photo-stable components or a combination of the two or water soluble anti-oxidants. Product bottles have normally a sleeve that prevents light penetration into the sample.

### Product Form

A composition for use in the invention may be in dry solid or liquid form. The composition may be a concentrate to be diluted, rehydrated and/or dissolved in a solvent, including water, before use. The composition may also be a ready-to-use (in-use) composition. Preferably the composition is provided as a ready to use liquid comprising an aqueous phase. The aqueous phase may comprise water-soluble species, such as mineral salts or short chain (C₁₋₄) alcohols.

The mineral salts may aid the attainment of the required phase volume for the composition, as may water soluble organic salts and cationic deflocculating polymers, as described in EP 41,698 A2 (Unilever). Such salts may be present at from 0.001 to 1% and preferably at from 0.005 to 0.1% by weight of the total composition. Examples of suitable mineral salts for this purpose include calcium chloride and magnesium chloride. The compositions of the invention may also contain pH modifiers such as hydrochloric acid. The short chain alcohols include primary alcohols, such as ethanol, propanol, and butanol, and secondary alcohols such as isopropanol. The short chain alcohol may be added with the cationic softening agent during the preparation of the composition.

The composition is preferably a fabric softener or fabric conditioner composition, and is preferably for use in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

The compositions of the invention are not detergent compositions and are preferably substantially free (for example having less than 0.1 weight %, preferably less than 0.05 weight % by weight of the total composition), more preferably free from one or more detersive surfactants such as anionic, non-ionic, ampholytic, zwitterionic surfactants, and cleaning soaps.

We have also found that in the presence of cationic softeners the deposition of photo-bleaches from solutions on to fabrics is almost 100% and hence much smaller levels of photobleach are required in fabric softening compositions compared to detergent compositions.

It is also possible, though less desirable, for the compositions of the present invention to be used in industrial laundry operations, e.g. as a finishing agent for softening new clothes prior to sale to consumers.

### Method of Manufacture

In a typical method of manufacture, the cationic softening agent, and any optional components such as co-softener or complexing agent are heated together until a co-melt is formed. Water and other components are heated and the co-melt is added to the water with stirring. The photo-bleaches can be dosed, as a solution, at the end of the process when the batch is cooled to room temperature before or after perfume addition.

The photobleach is used to reduce base off-odour in a composition comprising a quaternary ammonium compound, wherein the quaternary ammonium compound has unsaturated fatty chains. Uses to improve freshness of laundered articles, improve clean smell of laundered articles, reduce musty smell and improve the longevity of fragrance of a laundry conditioning product are also covered by this invention.

### EXAMPLES

Embodiments of the invention are now illustrated with reference to the following non-limiting examples. Unless stated otherwise, all proportions are given in weight percent by weight of the total composition.

### Example 1

### Preparation of Compositions 1 and 2

Composition 1 and Composition 2 were prepared in a bench top mixer equipped with a top 3-stage stirrer and a recirculation bath for temperature control.

The cationic softening agent, and complexing agent were heated together until a co-melt was formed. Water was heated and the co-melt added to the water with stirring. The batch was cooled to room temperature and sampled in a brown bottle.

The process conditions were as follows:

Batch water temperature=45° C.;

Co-melt temperature=60° C.;

Co-melt addition time=3 minutes;

Mixing time=8 minutes;

Cooling time by cold water recirculation=5 minutes;

Mixing speed=500 RPM;

Batch size=200 g.

TABLE 1
Compositions 1 and 2

| Ingredients | Composition 1 | Composition 2 |
|---|---|---|
| Stepantex VT90 | 4.4 | 0 |
| Stepantex SP90 | 0 | 4.4 |
| Stenol 16/18 L | 0.48 | 0.48 |
| Demineralised | to 100 | to 100 |
| water | | |

Stepantex VT90 (ex Stepan) is a soft tallow TEA quaternary ammonium softening compound containing 90% active and 10% IPA.

Stepantex SP90 (ex Stepan) is a palm oil based TEA quaternary ammonium compound.

Stenol 16/18 L (ex Cognis) is a fatty alcohol (complexing agent) with a mixture of C16 and C18 saturated chains.

Table 2 gives the level of unsaturation and the odour description of the two actives.

TABLE 2
Chain distribution and odour description of VT90 and SP90.

| Softener | Odour | | | | | | | | | |
|---|---|---|---|---|---|---|---|---|---|---|
| material | Description | C10 | C12 | C14 | C14uns | C16 | C16:1 | C18 | C18:1 | C18:2 |
| VT90 | Fatty/ | 0.1 | 0.1 | 2.7 | 0.3 | 30.6 | 2.2 | 32.6 | 28.6 | 2.8 |
| | tallow | | | | | | | | | |
| SP90 | oily | 0.1 | 0.1 | 0.6 | 0 | 45.6 | 0.2 | 15.2 | 32.6 | 5.5 |

### Example 2

### Evaluation of the Base Odour in Presence of Photo-Bleach (Acid Red 51)

Nine terry towelling monitors measuring about 20×20 cm were desized by twice by washing in a washing machine at 90° C. Three sets of three monitors were placed in three Tergo pots with 1 litre of demineralised water per pot and agitated for 10 minutes.

One set of three monitors were used as control. One of the remaining sets of three monitors was dosed with 2 g of Composition 1 and allowed to agitate for a further 10 minutes. The remaining three monitors were dosed with 2 g of Composition 2 and allowed to agitate for a further 10 minutes.

One monitor was removed from each pot and spin and line dried.

To each of the three Tergo pots 0.01 g of Acid Red 51 photo-bleach was added and the monitors agitated for 15 minutes. Acid Red 51 is erythrosine B (ex Aldrich). From each set one monitor was line dried (inside) and one dried in a Weather-o-meter™ (WOM) for 30 minutes. The (WOM) produces artificial sunlight and was set to give 385 W/m² in the UV-visible range (290-750 nm) at 6% RH.

After drying, all monitors were stored in clear closed-top bottles and kept for three days in darkened conditions before presenting them to an expert panel for odour evaluation. The odour descriptors used were based on those known in the art. The panel members described the odour and assigned a number to quantify the intensity of the odour they perceived (0=no base odour, 5=very intense base odour).

The results of the odour evaluation are summarised in Table 3.

TABLE 3
Odour intensity and odour description of treated
monitors with and without Acid red 51 (at 0.001% w), after 3
days of storage.

| | Average odour | |
|---|---|---|
| Monitor | intensity | Odour description |
| Control - line dried | 0 | Clean, neutral |
| Control - WOM dried | 0 | Clean, neutral |
| Control with | 0 | Clean, fresh |
| photobleach - line dried | | |
| Control with photobleach - | 0 | Clean, fresh, ozonic |
| WOM dried | | |
| VT90 - line dried | 1.5 | Fatty, oily |
| VT90 - WOM dried | 2.0 | Fatty, oily |
| VT90 with photobleach | 0.5 | Slightly fatty, pleasant |
| line dried | | |
| VT90 with photobleach | 0 | Clean, ozonic, fresh |
| WOM dried | | |
| SP90 - line dried | 1.0 | Oily, fatty |
| SP901 - WOM dried | 1.5 | Oily, fatty |
| SP90 with photobleach - | 0.5 | Slightly oily, |
| line dried | | |
| SP90 with photobleach - | 0 | Clean, fresh, faint caramel |
| WOM dried | | |

The base odour of SP90 was less intense and less offensive that VT90.

It will be seen that the presence of photobleach has eliminated the unpleasant fatty oily/rancid odour residue on the monitors.

The WOM dried monitors without photobleach have developed a stronger fatty oily/rancid smell perhaps because of increased auto-oxidation by light/heat due to the weather-o-meter treatment.

On the other hand the photo-oxidation in presence of photobleach has eliminated the base odour and improved the pleasantness of the monitors

### Example 3

### Evaluation of the Base Odour in Presence of Photo-Bleach (Tinolux BBS)

The same procedure as described above was followed, using the photobleach Tinolux BBS (ex Ciba) and VT90.

Table 4 summarizes the panel evaluation of the monitors.

TABLE 4
First day average odour intensity and description
of VT90 treated monitors in presence of three Tinolux BBS
levels.

| | Photobleach level | | |
|---|---|---|---|
| | | | 0.00003% by |
| | | 0.0001% by wt of | weight of |
| | | total | total |
| Treatment | 0% wt | composition | composition |
| Control - line | 0, Clean, flat, | 0, clean, fresh | 0, clean, |
| dried | stale | | fresh, |
| Control - WOM | 0, Clean | 0, clean, fresh | 0, clean, |
| dried | | | fresh |
| VT90 - line dried | 1.5, fatty | 0, clean, fresh, | 0, clean, |
| | | pleasant | fresh |
| VT90 - WOM dried | 2.0, fatty | 0, clean, fresh, | 0, clean, |
| | | pleasant | fresh |

Surprisingly, not only the base fatty odour is eliminated by the use of photobleach, pleasant fresh odours have been generated (green, aldehydic notes) more so at the higher level of 0.0003% wt.

In comparison with Acid Red 51 less ozonic odours were noticed here. It is likely that the iodine atoms in Acid Red 51 are dissociated under UV action to generate I₂ which has an ozonic smell.

A noticeable effect of the photo-bleach was that it changed the smell of cotton. Cotton control line dried inside had a slightly musty off odour as if it has been used. This disappears when dried in weather-o-meter and freshness emerges.

With photo-bleach the musty off odour is not present and cloths smell neutral whereas with the presence both of photo-bleach and UV light a stronger freshness and clean smell develops.

The above monitors were kept in closed top bottles and odours evaluated on the third day as summarised in Table 5.

TABLE 5
Day 3 average odour intensity and description of
VT90 treated monitors in presence of three Tinolux BBS
levels.

| | Photobleach | | |
|---|---|---|---|
| | level | | |
| | 0% w | 0.0001% w | 0.00003% w |
| Control - line | 0, stale | 0, clean, fresh | 0, clean, fresh |
| dried | | | |
| Control - WOM | 0, clean | 0, clean, fresh | 0, clean, fresh |
| dried | | | |
| VT90 - line | 2.5, fatty, rancid | 0.5, clean | 1.0, fatty, |
| dried | | fresh, slightly | slightly |
| | | fatty | rancid |
| VT90 - WOM dried | 2.5, fatty, rancid | 0, clean, | 0, clean, fresh |
| | | fresh, | |

It will be seen that even at very low levels, the presence of the photobleach acts to reduce the off-odour intensity. The results in Tables 4 and 5 with Tinolux were repeated with AR51 instead and found to be similar with more ozonic odours present at the higher 0.0003 level.

### Example 4

### Evaluation of the Colour of Monitors in Presence of Photo-Bleach Blends

Tinolux BBS gives white fabrics a green-blue colour whereas Acid Red 51 dyes white cotton red. The desired blue white hue can be obtained by a judicial blend of the two photo-bleaches. This is demonstrated in the colour evaluation below.

White woven cotton cloth was washed at 20° C. in 2.0 g/L of a base washing powder containing: 18% NaLAS, 73% salts (silicate, sodium tri-poly-phosphate, sulphate, carbonate), 3% minors including fluorescer and enzymes, remainder impurities and water. A liquor to cloth of 30:1 was used, each wash lasted for 30 mins, and was conducted with and without the addition of varying level of Tinolux BBS and Acid Red 51. The level of dye was quantified by the optical absorption (5 cm path length) at 528 nm for Acid Red 51 and 670 nm for the Tinolux BBS.

Following the wash, the cotton cloth was rinsed twice, dried and colour of the cloth was then assessed using a reflectometer (UV excluded for all measurements) and expressed as the hue angle. A hue angle of 180 corresponds to green, a hue angle of 270 to blue and a hue angle of 360 to red. The results are shown in Table 6 below:

TABLE 6
The colour of white cotton monitors in presence of
photo-bleach blend.

| | Absorption | |
|---|---|---|
| Absorption | (Tinolux BBS at | Hue |
| (AR51 at 528 nm) | 670 nm) | angle |
| 0 | 1.2 | 209 |
| 0.03 | 1.17 | 225 |
| 0.06 | 1.14 | 243 |
| 0.09 | 1.11 | 258* |
| 0.12 | 1.08 | 278** |
| 0.15 | 1.05 | 295** |
| 0.18 | 1.02 | 301* |
| 0.21 | 0.99 | 306* |
| 0.24 | 0.96 | 308* |
| 0.3 | 0.9 | 322 |
| 0.6 | 0.6 | 331 |
| 0.9 | 0.3 | 334 |
| 1.2 | 0 | 337 |

For whiteness preferred hue angles are between 250 and 320, preferably 270 to 300 (as marked with asterisks). As noted above, this may be provided by a mixture of an Acid Red xanthene photobleach and a green-blue sulphonated Zn/Al phthalocyanine photobleach.

### Example 5

### Preparation of Composition 3

The following composition (Composition 3) was made at 3 litre scale. Tinolux BMC (Ciba) was post-dosed in 10% of the batch water, which was withdrawn.

TABLE 7
Composition 3

| Ingredient | Amount (wt %) |
|---|---|
| Stepantex VT90 | 11.11 |
| Stenol 1618L | 0.50 |
| Dequest 2010 | 0.01 |
| Proxel GXL | 0.04 |
| Iriodin 111 | 0.05 |
| BF20+ | 0.05 |
| Tinolux BMC | 0.0015 |
| Demin Water | to 100 |

Method:

1. The batch water was heated to 40° C. (+/−2)

2. Dequest 2010 was then added.

3. Antimicrobial Proxel GXL was then added.

4. Antifoam BF20+ was then added.

5. Pearlescer Iriodin 111 was then added.

6. The mixture was then stirred for 2 minutes.

7. A co-melt of Stepantex VT90 and Stenol 1618L was then added over 3 minutes (co-melt temperature was 55° C.+/−2)

8. The resulting mixture was hot mixed for 5 minutes before being cooled to 30° C.

9. Finally, Tinolux BMC solution was added.

The resulting product showed no stability issue (specifically no increase in viscosity or malodour) on storage at a range of ambient temperatures. Fabric conditioners were shown to improve the deposition of photobleaches compared to water or detergent formulations.

1. A composition comprising a quaternary ammonium compound and a photobleach, wherein the quaternary ammonium compound has unsaturated fatty chains.

2. A composition according to claim 1, wherein the quaternary ammonium compound is derived from fatty feed stock having an Iodine Value of from 20 to 140, preferably from 20 to 60, more preferably from 20 to 50, most preferably from 25 to 45.

3. A composition according to claim 1 or claim 2, wherein the photo-bleach is a singlet oxygen photo-bleach.

4. A composition according to any preceding claim, wherein the photo-bleach comprises a combination of singlet oxygen photobleaches.

5. A composition according to claim 3 or claim 4, wherein the photo-bleach is selected from the group consisting of Acid Red 51, Tinolux BBS, Tinolux BMC and mixtures thereof.

6. A composition according to any preceding claim, wherein the photo-bleach is present at a level of from 0.00003 to 0.05, preferably from 0.0001 to 0.04, more preferably from 0.002% to 0.04% by weight of the total composition.

7. A composition according to any preceding claim, wherein the quaternary ammonium compound is an ester-linked triethanolammonium (TEA) quaternary ammonium compound.

8. A composition according to any preceding claim, wherein the quaternary ammonium compound is present at a level of from 3 to 50%, preferably 4 to 40, more preferably 5 to 30, by weight of the total composition.

9. A composition according to any preceding claim, wherein the composition further comprises a fatty complexing agent.

10. A composition according to any preceding claim, wherein the composition further comprises perfume.

11. A composition according to claim 10, wherein the perfume is present at a level of from 0.01 to 10% by weight of the total composition.

12. A composition according to any preceding claim, wherein the composition further comprises a blue or violet shading dye.

13. Use of a photobleach to reduce base off-odour in a composition comprising a quaternary ammonium compound, wherein the quaternary ammonium compound has unsaturated fatty chains.

14. Use according to claim 13, wherein the composition is defined by any one of claims 2 to 12.

15. Use of a photobleach in a composition as defined by any one of claims 1 to 12 to improve freshness of laundered articles.

16. Use of a photobleach in a composition as defined by any one of claims 1 to 12 to improve clean smell of laundered articles.

17. Use of a photobleach in a composition as defined by any one of claims 1 to 12 to reduce musty smell.

18. Use of a photobleach in a composition as defined by any one of claims 1 to 12 to improve the longevity of fragrance of a laundry conditioning product.
